(19) United States
(12) Patent Application Publication
(10) Pub. No.: US 2011/0058381 A1
(43) Pub. Date: Mar. 10, 2011

(54) Optical Reflector Having A High Efficiency

(76) Inventors: Ray Chiang, Tainan City (TW); Jeffrey Huang, Kaohsiung City (TW); Patrick Chen, Tainan City (TW)

(21) Appl. No.: 12/556,762

(22) Filed: Sep. 10, 2009

(51) Int. Cl. F21V 7/04

(52) U.S. Cl. 362/349

(57) ABSTRACT

An optical reflector includes a reflector body (1) having a receiving space (11) and an opening (12). The receiving space of the reflector body has a peripheral wall provided with a reflective surface. The reflective surface of the reflector body includes a light splitting zone (14), two light scattering zones (15) and two light gathering zones (16). The light splitting zone of the reflective surface includes an elongate protrusion (141). Each of the two light scattering zones of the reflective surface includes a plurality of elongate arcuate convex portions (151). Each of the two light gathering zones of the reflective surface includes a plurality of elongate arcuate concave portions (161).

### BACKGROUND OF THE INVENTION

1. Field of the Invention

The present invention relates to a reflector and, more particularly, to an optical reflector for a lamp.

2. Description of the Related Art

A conventional optical reflector in accordance with the prior art shown in FIGS. 7-9 comprises a reflector body 3 having an inner portion provided with a receiving space 32 to receive a light emitting member 4 and a bottom provided with an opening 31 connected to the receiving space 32 to allow entrance of the light emitting member 4. The receiving space 32 of the reflector body 3 has a peripheral wall provided with a plurality of reflective surfaces 33 which are parallel with each other. The reflective surfaces 33 of the reflector body 3 are parallel with a longitudinal axis of the reflector body 3. Each of the reflective surfaces 33 of the reflector body 3 is a convex face. The reflector body 3 is made of an aluminum sheet plate that is worked by stamping. Each of the reflective surfaces 33 of the reflector body 3 is coated with a plated film layer that is made of aluminum or iron to function as a reflective medium.

However, the reflective surfaces 33 of the reflector body 3 are not designed to satisfy an optical requirement so that the reflective surfaces 33 of the reflector body 3 cannot reflect the light beams of the light emitting member 4 efficiently and cannot distribute the light beams evenly, thereby decreasing the reflective efficiency and decreasing the lighting effect. In addition, the reflector body 3 is made of metal that is easily expanded or deformed at a high temperature so that the plated film layer on each of the reflective surfaces 33 is easily broken or cracked, thereby decreasing the reflective effect. Further, the plated film layer on each of the reflective surfaces 33 is made of aluminum or iron so that the plated film layer is easily oxidated and stripped, thereby failing the reflective surfaces 33.

### BRIEF SUMMARY OF THE INVENTION

In accordance with the present invention, there is provided an optical reflector, comprising a reflector body having an inner portion provided with a receiving space and a bottom provided with an opening connected to the receiving space. The receiving space of the reflector body has a peripheral wall provided with a reflective surface. The reflective surface of the reflector body is a substantially curved hollow surface that is centered at a central axis which extends in a longitudinal direction of the reflector body. The reflective surface of the reflector body includes a light splitting zone, two light scattering zones and two light gathering zones. The light splitting zone of the reflective surface includes an elongate protrusion. The two light scattering zones of the reflective surface are located at two opposite sides of the light splitting zone respectively. Each of the two light scattering zones of the reflective surface includes a plurality of elongate arcuate convex portions. The two light gathering zones of the reflective surface are located at two opposite sides of the light splitting zone respectively. Each of the two light gathering zones of the reflective surface includes a plurality of elongate arcuate concave portions.

According to the primary objective of the present invention, the optical reflector can evenly distribute the lighting field of the light beams and can enhance the illuminance and brightness of the lamp.

According to another objective of the present invention, the power of the light emitting member can be reduced so as to decrease the energy consumption.

According to a further objective of the present invention, the reflective surface of the reflector body includes a light splitting zone, two light scattering zones and two light gathering zones which co-operate to distribute the light source, enhance the optical reflectivity efficiently, expand the lighting field, increase the lighting quality and to enhance the brightness, illuminance and evenness of the light emitting member.

According to a further objective of the present invention, the reflector body has greater optical reflectivity and brightness so that the light emitting member can have a smaller power so as to save the electrical energy.

According to a further objective of the present invention, the reflector body is made of glass that is not expanded or deformed at a high temperature to prevent the plated film layer of the reflective surface from being broken, oxidated or stripped so as to enhance the lifetime of the plated film layer.

According to a further objective of the present invention, the plated film layer of the reflective surface is added with a silver of a determined proportion so that the reflective surface of the reflector body has a better reflective efficiency.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective cross-sectional view of an optical reflector in accordance with the preferred embodiment of the present invention.

FIG. 2 is a locally enlarged view of the optical reflector as shown in FIG. 1.

FIG. 3 is a front cross-sectional view of the optical reflector as shown in FIG. 1.

FIG. 4 is a side cross-sectional operational view of the optical reflector as shown in FIG. 1.

FIG. 5 is a side cross-sectional operational view of the optical reflector as shown in FIG. 1.

FIG. 6 is a side cross-sectional operational view of the optical reflector as shown in FIG. 1.

FIG. 7 is a bottom view of a conventional optical reflector in accordance with the prior art.

FIG. 8 is a front cross-sectional view of the conventional optical reflector in accordance with the prior art.

FIG. 9 is a side cross-sectional view of the conventional optical reflector in accordance with the prior art.

### DETAILED DESCRIPTION OF THE INVENTION

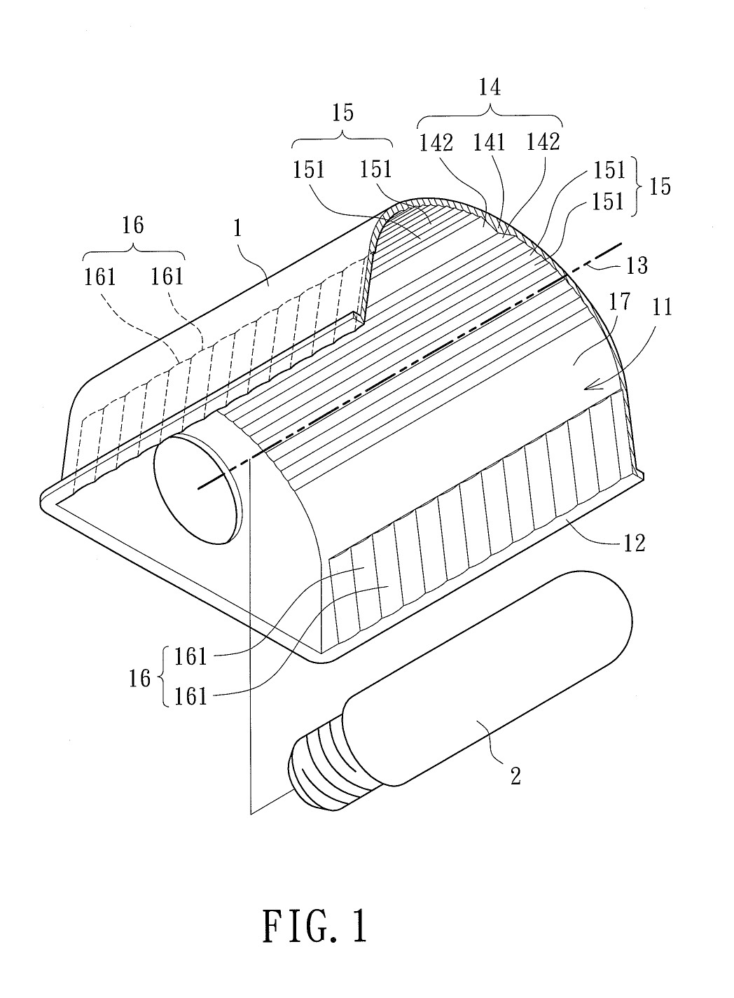

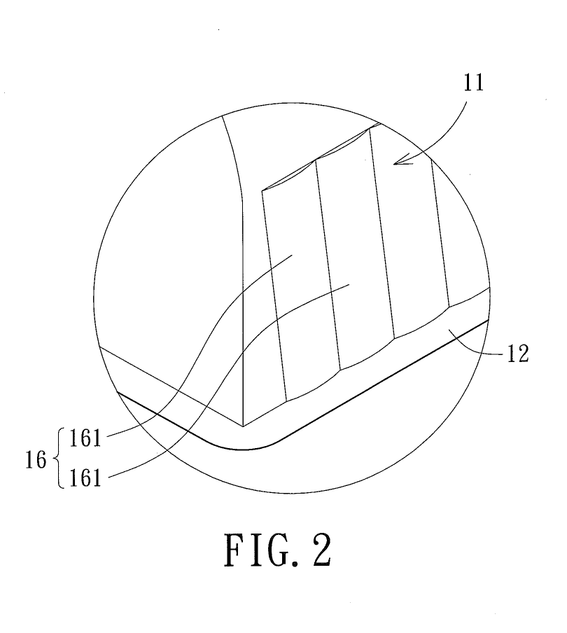

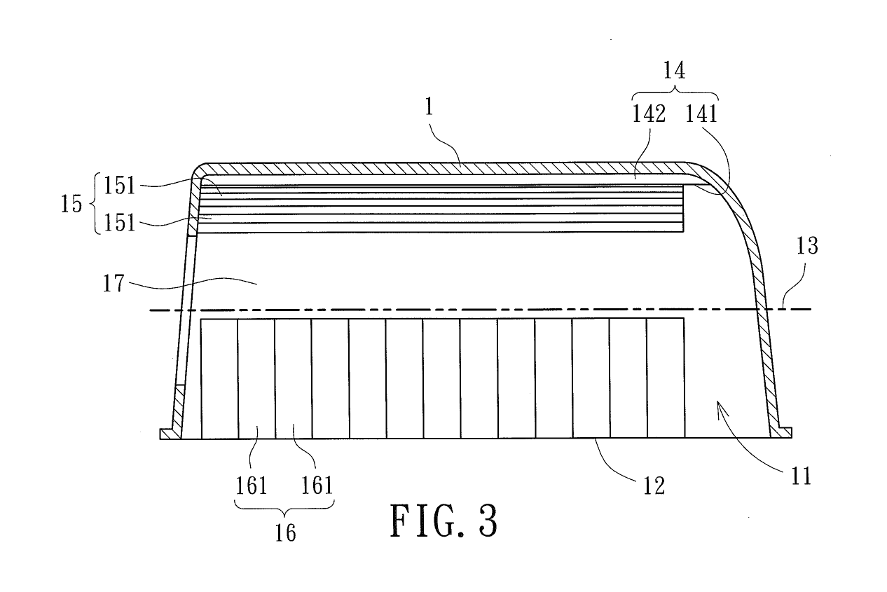

Referring to the drawings and initially to FIGS. 1-3, an optical reflector in accordance with the preferred embodiment of the present invention comprises a reflector body 1 having an inner portion provided with a receiving space 11 to receive a light emitting member 2 and a bottom provided with an opening 12 connected to the receiving space 11 to allow entrance of the light emitting member 2. The receiving space 11 of the reflector body 1 has a peripheral wall provided with a reflective surface. The reflective surface of the reflector body 1 is formed by a plated film layer with a high reflective feature. The plated film layer of the reflector body 1 is made of an aluminum which is added with a silver of a determined proportion.

The reflective surface of the reflector body 1 is a substantially curved hollow surface or parabolic concave surface that is centered at a central axis 13 which extends in a longitudinal direction of the reflector body 1. The light emitting member 2 is aligned with the central axis 13 of the reflector body 1. Preferably, the light emitting member 2 is an electric bulb or tube.

The reflective surface of the reflector body 1 includes a light splitting zone 14, two light scattering zones 15 and two light gathering zones 16.

The light splitting zone 14 of the reflective surface includes an elongate protrusion 141 which extends in a direction parallel with the central axis 13 of the reflector body 1. The protrusion 141 of the light splitting zone 14 is located at a middle position of the reflective surface to divide the reflective surface of the reflector body 1 into two symmetric regions. The light splitting zone 14 of the reflective surface further includes two light splitting faces 142 mounted on two opposite sides of the protrusion 141 symmetrically. Each of the two light splitting faces 142 of the light splitting zone 14 is a ramp and is located at a respective one of the two symmetric regions divided by the protrusion 141.

The two light scattering zones 15 of the reflective surface are located at two opposite sides of the light splitting zone 14 respectively. Preferably, the two light scattering zones 15 of the reflective surface are located at the two symmetric regions divided by the protrusion 141 and are located beside the two light splitting faces 142 of the light splitting zone 14 respectively. Each of the two light scattering zones 15 of the reflective surface includes a plurality of elongate arcuate convex portions 151. Each of the arcuate convex portions 151 of each of the two light scattering zones 15 extends in a direction parallel with the central axis 13 of the reflector body 1. The arcuate convex portions 151 of each of the two light scattering zones 15 are connected successively and serially and are entirely distributed over each of the two light scattering zones 15.

The two light gathering zones 16 of the reflective surface are located at two opposite sides of the light splitting zone 14 respectively. Preferably, the two light gathering zones 16 of the reflective surface are located at the two symmetric regions divided by the protrusion 141 and are located beside the opening 12 of the reflector body 1. Each of the two light gathering zones 16 of the reflective surface includes a plurality of elongate arcuate concave portions 161. Each of the arcuate concave portions 161 of each of the two light gathering zones 16 extends in a tangential direction of a curvature of the reflective surface. The arcuate concave portions 161 of each of the two light gathering zones 16 are connected successively and serially and are entirely distributed over each of the two light gathering zones 16. Each of the arcuate concave portions 161 of each of the two light gathering zones 16 has a lower end connected to the opening 12 of the reflector body 1.

The reflective surface of the reflector body 1 further includes two straight reflective zones 17 each located between a respective one of the two light scattering zones 15 and a respective one of the two light gathering zones 16. Each of the two straight reflective zones 17 of the reflective surface is a plane or a curved face.

In the preferred embodiment of the present invention, the reflector body 1 is preferably made of glass that is not expanded or deformed under the temperature of 300° C. and is not oxidated. In addition, the reflective surface of the reflector body 1 is formed by a plated film layer which is added with a silver of a determined proportion so that the reflective surface of the reflector body 1 has a better reflective efficiency.

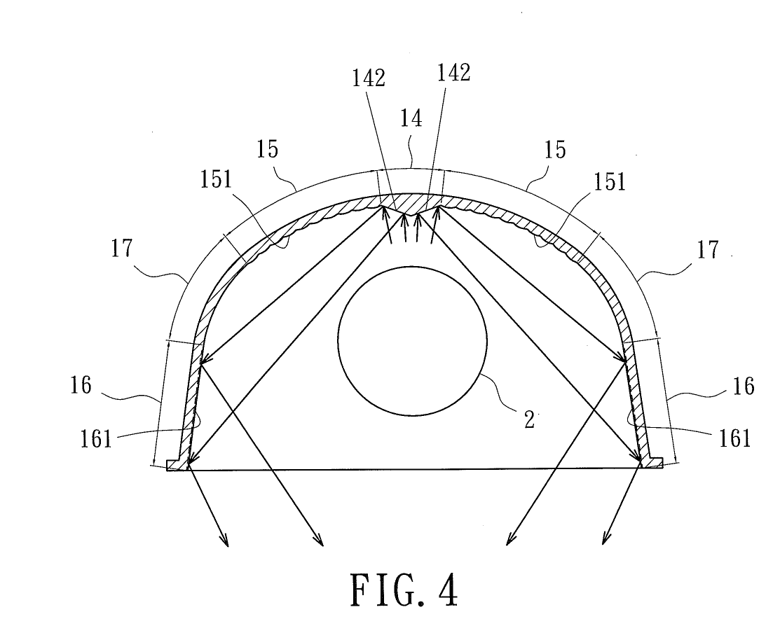

In operation, referring to FIG. 4 with reference to FIGS. 1-3, each of the two light splitting faces 142 of the light splitting zone 14 is directed toward a respective one of the two light gathering zones 16. Thus, the light beams emitted from the light emitting member 2 are reflected by each of the two light splitting faces 142 of the light splitting zone 14 and is projected onto each of the two light gathering zones 16 to prevent the light beams above the light emitting member 2 from being directly reflected back to the light emitting member 2 and from interfering with reflection of other light beams so as to prevent from incurring an optical loss.

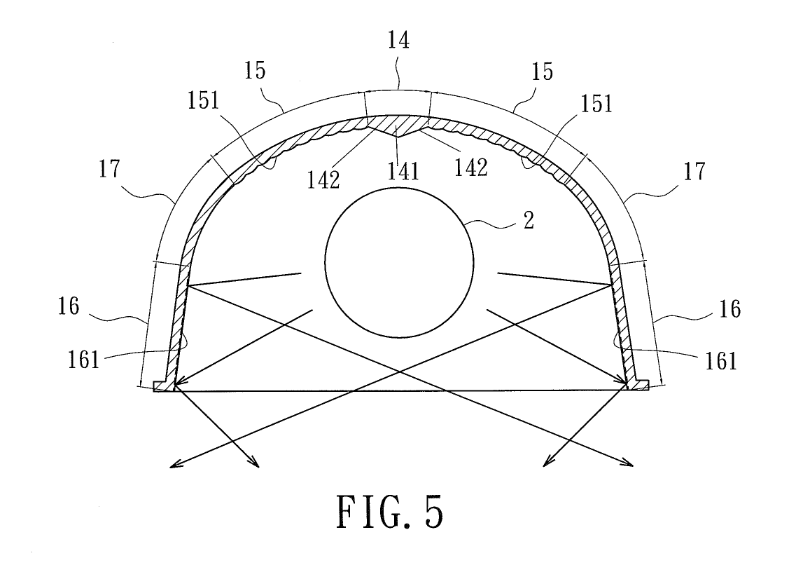

In addition, referring to FIG. 5 with reference to FIGS. 1-3, the light beams emitted from the light emitting member 2 are directly projected onto the two light gathering zones 16 which gather and reflect the light beams to a farther position to enhance the brightness of the light emitting member 2. Thus, the arcuate concave portions 161 of each of the two light gathering zones 16 can reflect the light beams from the light emitting member 2 in multiple directions and angles so as to enhance the illuminance of the light emitting member 2 evenly and smoothly.

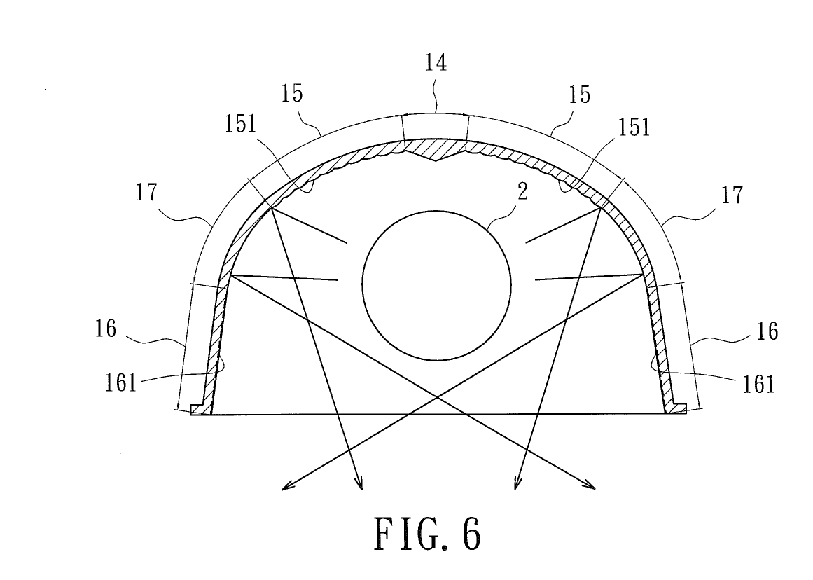

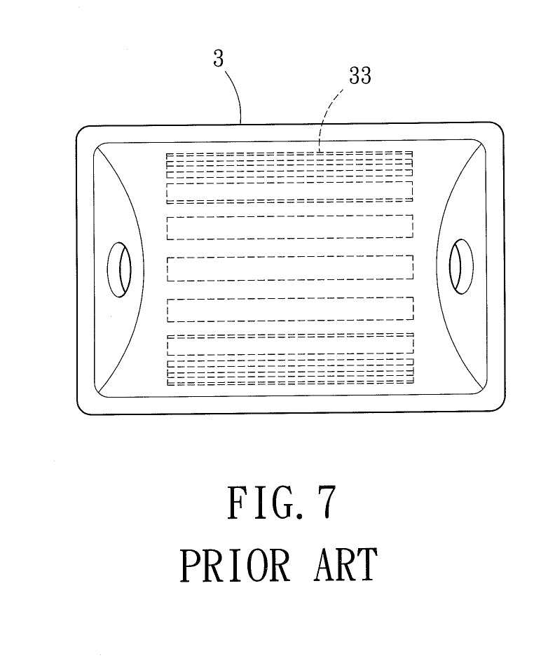

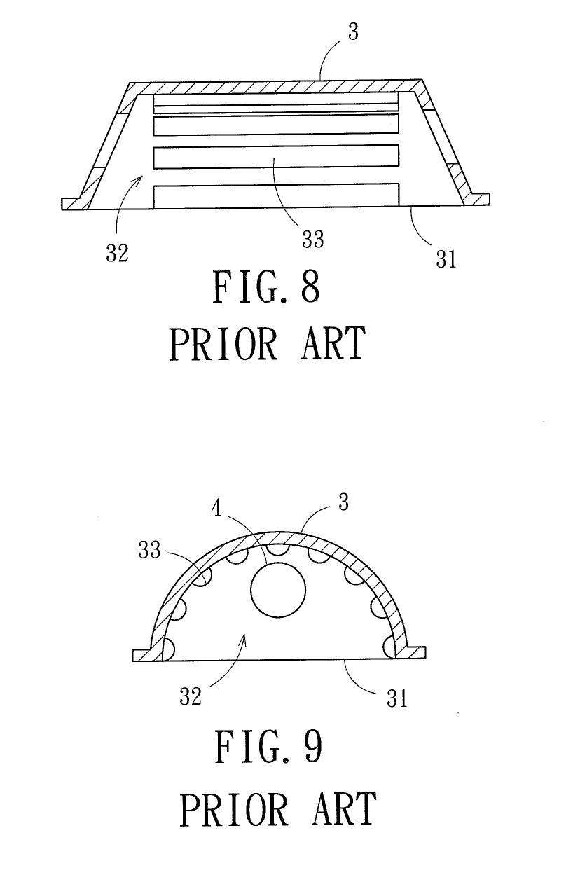

In addition, referring to FIG. 6 with reference to FIGS. 1-3, when the light beams emitted from the light emitting member 2 are projected onto the two light scattering zones 15 of the reflective surface, the arcuate convex portions 151 of each of the two light scattering zones 15 can scatter and distribute the light beams which are reflected many times by other reflective faces.

In addition, again referring to FIG. 6 with reference to FIGS. 1-3, when the light beams emitted from the light emitting member 2 are projected onto the two straight reflective zones 17 of the reflective surface, the light beams are directly reflected by the two straight reflective zones 17 of the reflective surface so as to compensate the illuminance of the linear light.

Accordingly, the reflective surface of the reflector body 1 includes a light splitting zone 14, two light scattering zones 15 and two light gathering zones 16 which co-operate to distribute the light source, enhance the optical reflectivity efficiently, expand the lighting field, increase the lighting quality and to enhance the brightness, illuminance and evenness of the light emitting member 2. In addition, the reflector body 1 has greater optical reflectivity and brightness so that the light emitting member 2 can have a smaller power so as to save the electrical energy. Further, the reflector body 1 is made of glass that is not expanded or deformed at a high temperature to prevent the plated film layer of the reflective surface from being broken, oxidated or stripped so as to enhance the lifetime of the plated film layer. Further, the plated film layer of the reflective surface is added with a silver of a determined proportion so that the reflective surface of the reflector body 1 has a better reflective efficiency.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An optical reflector, comprising:
a reflector body (1) having an inner portion provided with a receiving space (11) and a bottom provided with an opening (12) connected to the receiving space; wherein
the receiving space of the reflector body has a peripheral wall provided with a reflective surface;
the reflective surface of the reflector body is a substantially curved hollow surface that is centered at a central axis (13) which extends in a longitudinal direction of the reflector body;
the reflective surface of the reflector body includes a light splitting zone (14), two light scattering zones (15) and two light gathering zones (16);
the light splitting zone of the reflective surface includes an elongate protrusion (141);
the two light scattering zones of the reflective surface are located at two opposite sides of the light splitting zone respectively;
each of the two light scattering zones of the reflective surface includes a plurality of elongate arcuate convex portions (151);
the two light gathering zones of the reflective surface are located at two opposite sides of the light splitting zone respectively;
each of the two light gathering zones of the reflective surface includes a plurality of elongate arcuate concave portions (161).

2. The optical reflector of claim 1, wherein the protrusion of the light splitting zone extends in a direction parallel with the central axis of the reflector body.

3. The optical reflector of claim 1, wherein each of the arcuate convex portions of each of the two light scattering zones extends in a direction parallel with the central axis of the reflector body.

4. The optical reflector of claim 1, wherein each of the arcuate concave portions of each of the two light gathering zones extends in a tangential direction of a curvature of the reflective surface.

5. The optical reflector of claim 1, wherein each of the arcuate concave portions of each of the two light gathering zones has a lower end connected to the opening of the reflector body.

6. The optical reflector of claim 1, wherein
the protrusion of the light splitting zone is located at a middle position of the reflective surface to divide the reflective surface of the reflector body into two symmetric regions;
the light splitting zone of the reflective surface further includes two light splitting faces (142) mounted on two opposite sides of the protrusion symmetrically;
each of the two light splitting faces of the light splitting zone is located at a respective one of the two symmetric regions divided by the protrusion.

7. The optical reflector of claim 6, wherein
the two light scattering zones of the reflective surface are located at the two symmetric regions divided by the protrusion;
the two light scattering zones of the reflective surface are located beside the two light splitting faces of the light splitting zone respectively.

8. The optical reflector of claim 6, wherein
the two light gathering zones of the reflective surface are located at the two symmetric regions divided by the protrusion;
the two light gathering zones of the reflective surface are located beside the opening of the reflector body.

9. The optical reflector of claim 1, wherein the reflective surface of the reflector body further includes two straight reflective zones (17) each located between a respective one of the two light scattering zones and a respective one of the two light gathering zones.

10. The optical reflector of claim 9, wherein each of the two straight reflective zones of the reflective surface is a plane.

11. The optical reflector of claim 9, wherein each of the two straight reflective zones of the reflective surface is a curved face.

12. The optical reflector of claim 6, wherein each of the two light splitting faces of the light splitting zone is a ramp.

13. The optical reflector of claim 6, wherein each of the two light splitting faces of the light splitting zone is directed toward a respective one of the two light gathering zones.

14. The optical reflector of claim 1, wherein the arcuate convex portions of each of the two light scattering zones are connected successively and serially.

15. The optical reflector of claim 1, wherein the arcuate convex portions of each of the two light scattering zones are entirely distributed over each of the two light scattering zones.

16. The optical reflector of claim 1, wherein the arcuate concave portions of each of the two light gathering zones are connected successively and serially.

17. The optical reflector of claim 1, wherein the arcuate concave portions of each of the two light gathering zones are entirely distributed over each of the two light gathering zones.
